(19) United States
(12) Patent Application Publication
(10) Pub. No.: US 2012/0296085 A1
(43) Pub. Date: Nov. 22, 2012

(54) CHEMILUMINESCENT DYES AND DYE-STAINED PARTICLES

(75) Inventor: Bradley Smith, Granger, IN (US)

(73) Assignee: University of Notre Dame du Lac, Notre Dame, IN (US)

(21) Appl. No.: 13/522,296

(22) PCT Filed: Jun. 1, 2010
(86) PCT No.: PCT/US10/36912

§ 371 Date: Jul. 13, 2012

Related U.S. Application Data
(60) Provisional application No. 61/335,846, filed on Jan. 13, 2010.

(51) Int. Cl. C09B 5/00; B01J 19/12

(52) U.S. Cl. 540/460; 204/157.82

(57) ABSTRACT

Chemiluminescent compounds that can be activated by reaction with chemical or photochemical sources of singlet oxygen are provided. At certain temperatures, such as from approximately 15 to 60° C., the compounds slowly return to their deactivated state by emitting visible and/or infrared light that is observable with various types of light detectors. Suitable conjugates of these compounds, or small particles containing these compounds, may be used for chemiluminescence imaging and sensing technologies. In particular, embodiments provide optical molecular imaging using novel squaraine rotaxane endoperoxides (SREPs) and squaraine catenane endoperoxides (SCEPs), interlocked fluorescent and chemiluminescent dye molecules that have a squaraine chromophore encapsulated inside a macrocycle endoperoxide. The dyes may be stored at low temperature, such as below 0° C., but, upon warming above 15° C., such as to body temperature, they undergo a unimolecular cycloreversion reaction that releases singlet oxygen and emits visible or near-infrared light that can pass through living tissue. The chemiluminescent signal is detectable with inherently high contrast because there is negligible background emission.

### CROSS REFERENCE TO RELATED APPLICATIONS

The present application claims priority to U.S. Provisional Patent Application No. 61/335,846, filed Jan. 13, 2010, entitled “Chemiluminescent Compounds,” the entire disclosure of which is hereby incorporated by reference in its entirety.

### GOVERNMENT INTERESTS

This invention was made with Government support under Grant/Contract No. CHE 0748761 awarded by the National Science Foundation. The Government has certain rights in the invention.

### TECHNICAL FIELD

Embodiments herein relate to the field of chemistry, and, more specifically, to novel chemiluminescent dyes and dye-stained particles, synthesis thereof, and methods of using same.

### BACKGROUND

Optical microscopy and molecular imaging employs harmless low energy light and technically straightforward instrumentation. Self-illuminating, chemiluminescent systems are especially attractive since they have inherently high signal contrast due to the lack of background emission. Currently, chemiluminescence detection and imaging involves short-lived molecular species that are not stored but instead are generated in situ, by stoichiometric or enzymatic oxidation reactions. Most chemiluminescent compounds emit visible light, which is relatively harmless and easily detected, but it is readily absorbed and scattered by biological matrices and does not penetrate far through heterogeneous biological media. These factors combine to limit the utility of chemiluminescence in certain imaging, diagnostics, and microscopy applications.

### BRIEF DESCRIPTION OF THE DRAWINGS

Embodiments will be readily understood by the following detailed description in conjunction with the accompanying drawings and the appended claims. Embodiments are illustrated by way of example and not by way of limitation in the figures of the accompanying drawings.

FIG. 1 shows thermally-activated cycloreversion of compound 1EP releasing singlet oxygen and emitting near-infrared light in accordance with various embodiments; the encapsulated component in rotaxane compound 1 and compound 1EP is the squaraine compound 3; the surrounding macrocycle in compound 1 is compound 2.

FIG. 2 shows ¹H NMR spectra illustrating the photoconversion of compound 1 into compound 1 EP in accordance with various embodiments; partial ¹H NMR spectra in CDCl₃ show a) compound 1, b) a mixture of compound 1 and compound 1EP after irradiation with red light for 10 minutes, and c) complete conversion to compound 1EP after irradiation for 30 minutes; the specific atom labeling corresponds to that shown in FIG. 1 for compounds 1 and 1EP;

FIG. 3 illustrates an exemplary synthesis of SREP 1 in accordance with an embodiment herein;

FIG. 4 illustrates an exemplary synthesis of SREP 2 in accordance with an embodiment herein;

FIG. 5 shows solid support images of green emitting SREP 2 and red emitting SREP 1, as follows: a) photographic image, b) no filter, c) red Cy5.5 filtered, d) green GFP filtered, and e) combination of images c and d;

FIG. 6 illustrates an exemplary synthesis of SREP 3 in accordance with an embodiment herein;

FIG. 7 illustrates false-colored pixel intensity maps at 38° C. with intensity scales in arbitrary units in accordance with various embodiments; a) vial containing a solution of chemiluminescent compound 1EP in CDCl₃, b) fluorescence micrograph of carboxylate functionalized polystyrene 1EP-microparticles (0.9 μm diameter), c) chemiluminescence from polystyrene 1EP-microparticles that are aggregated in a vial of water (viewed from the top of the vial), d) chemiluminescence from carboxylate functionalized polystyrene 1EP-microparticles that are dispersed throughout a vial of water, and e), f), and g) bright field, chemiluminescence, and fluorescence images, respectively, of a reverse-phase TLC plate with spots of compound 1EP;

FIG. 8 illustrates chemiluminescence and reflected fluorescence from 1EP-microparticles injected subcutaneously into the dorsal side of a nude mouse rear leg at 38° C.; a), b), and c) dorsal bright field, chemiluminescence, and fluorescence images respectively (chemiluminescence and fluorescence TBR (target to background ratio)=14 and 30, respectively), and d), e), and f), ventral images which require light penetration through deeper tissue and produce lower contrast (chemiluminescence and fluorescence TBR=10 and 4.4, respectively) (N=4);

FIG. 9 shows that chemiluminescence from compound 1EP at 38° C. penetrates through a living nude mouse; a) and f) experimental set-up for chemiluminescence and fluorescence imaging, respectively, b) and g) chemiluminescence and fluorescence pixel intensities from a small tube containing compound 1EP (250 nmol) in C₂D₂Cl₄, c) and h) photograph of mouse located above the tube, d) and e) pixel intensity map of chemiluminescence that is transmitted through the mouse (TBR=12), i) fluorescence intensity map of mouse located above the tube (TBR=1.1), and j) fluorescence intensity map of mouse with no tube present;

FIG. 10 illustrates an exemplary SREP monomer (5), dimer (6), and trimer (7) in accordance with embodiments herein;

FIG. 11 is a graph comparing integrated chemiluminescent counts of symmetric SREP monomers and asymmetric SREP monomers, as well as SREP dimers and trimers, in accordance with embodiments herein;

FIG. 12 shows a squaraine rotaxane with a phenylene containing macrocycle in accordance with embodiments herein; and

FIG. 13 illustrates an exemplary synthesis of SCEP1 in accordance with an embodiment herein.

### DETAILED DESCRIPTION OF DISCLOSED EMBODIMENTS

In the following detailed description, reference is made to the accompanying drawings which form a part hereof, and in which are shown by way of illustration embodiments that may be practiced. It is to be understood that other embodiments may be utilized and structural or logical changes may be made without departing from the scope. Therefore, the following detailed description is not to be taken in a limiting sense, and the scope of embodiments is defined by the appended claims and their equivalents.

Various operations may be described as multiple discrete operations in turn, in a manner that may be helpful in understanding embodiments; however, the order of description should not be construed to imply that these operations are order dependent.

The description may use perspective-based descriptions such as up/down, back/front, and top/bottom. Such descriptions are merely used to facilitate the discussion and are not intended to restrict the application of disclosed embodiments.

The terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

For the purposes of the description, a phrase in the form “A/B” or in the form “A and/or B” means (A), (B), or (A and B). For the purposes of the description, a phrase in the form “at least one of A, B, and C” means (A), (B), (C), (A and B), (A and C), (B and C), or (A, B and C). For the purposes of the description, a phrase in the form “(A)B” means (B) or (AB) that is, A is an optional element.

The description may use the terms “embodiment” or “embodiments,” which may each refer to one or more of the same or different embodiments. Furthermore, the terms “comprising,” “including,” “having,” and the like, as used with respect to embodiments, are synonymous, and are generally intended as “open” terms (e.g., the term “including” should be interpreted as “including but not limited to,” the term “having” should be interpreted as “having at least,” the term “includes” should be interpreted as “includes but is not limited to,” etc.).

With respect to the use of any plural and/or singular terms herein, those having skill in the art can translate from the plural to the singular and/or from the singular to the plural as is appropriate to the context and/or application. The various singular/plural permutations may be expressly set forth herein for sake of clarity.

As used herein, the term “halogen” refers to fluoro, bromo, chloro, and iodo substituents.

As used herein, the term “alkyl” refers to a cyclic, branched, or straight chain alkyl group containing only carbon and hydrogen, and unless otherwise mentioned contains one to twelve carbon atoms. This term may be further exemplified by groups such as methyl, ethyl, n-propyl, isopropyl, isobutyl, t-butyl, pentyl, hexyl, heptyl, adamantyl, and cyclopentyl. Alkyl groups may either be unsubstituted or substituted with one or more substituents, for instance, halogen, het, alkyl, cycloalkyl, cycloalkenyl, alkoxy, alkylthio, trifluoromethyl, acyloxy, hydroxy, mercapto, carboxy, aryloxy, aryl, arylalkyl, heteroaryl, amino, alkylamino, dialkylamino, cyano, nitro, morpholino, piperidino, pyrrolidin-1-yl, piperazin-1-yl, or other functionality. As used herein, the term “het” refers to a mono- or bi-cyclic ring system containing one or more heteroatom selected from O, S, and N. Each mono-cyclic ring may be aromatic, saturated or partially unsaturated. A bi-cyclic ring system may include a mono-cyclic ring containing one or more heteroatom fused with a cycloalkyl or aryl group. A bi-cyclic ring system may also include a mono-cyclic ring containing one or more heteroatom fused with another het, mono-cyclic ring system.

As used herein, the term “cycloalkyl” refers to a cyclic alkyl moiety. Unless otherwise stated, cycloalkyl moieties include between 3 and 8 carbon atoms.

As used herein, the term “sulfone” refers to a chemical compound containing a sulfonyl functional group attached to two carbon atoms. The central sulfur atom is twice double bonded to oxygen and has two further hydrocarbon substituents. The general structural formula is R—S(═O)(═O)—R′ where R and R′ are the organic groups. As used herein, the term “aryl” refers to phenyl and naphthyl. As used herein, the term “heteroaryl” refers to a mono- or bicyclic het in which one or more cyclic ring is aromatic. As used herein, the term “substituted heteroaryl” refers to a heteroaryl moiety substituted with one or more functional groups selected from halogen, alkyl, hydroxyl, amino, alkoxy, cyano, and nitro. As used herein, the term “triazole” refers to either one of a pair of isomeric chemical compounds with molecular formula C₂H₃N₃, having a five-member ring of two carbon atoms and three nitrogen atoms. As used herein, the term “sulfonate” refers to an anion with the general formula RSO₂O—. Sulfonates are the conjugate bases of sulfonic acids with formula RSO₂OH. As used herein, the term “phosphonate” refers to organic compounds containing C—PO(OH)₂ or C—PO(OR)₂ groups (where R=alkyl or aryl). As used herein, the term “polyethylene glycol” refers to a chemical compound composed of one or more ethoxy units (—OCH₂CH₂—) in a repeating linear series. The series may begin or end with a hydroxyl group (—OH groups) or other functionality.

As used herein, the term “succinimide” refers to a cyclic imide with the formula C₄H₅NO₂. As used herein, the term “maleimide” refers to, the chemical compound with the formula H₂C₂(CO)₂NH.

Embodiments herein provide a new family of chemiluminescent compounds that may be prepared in their activated form by exposure to chemical or photochemical sources of singlet oxygen. At certain temperatures, such as from approximately 15 to 60° C., the compounds slowly return to their deactivated state and during this process emit visible and/or infrared light that is observable with various types of light detectors. It is known that chemiluminescence typically emits less light than fluorescence but, because the background signal is very low, chemiluminescence is a more sensitive technique than fluorescence. Such chemiluminescent compounds thus may be useful in various biotechnology methods such as Western blots, ELISA, cell microscopy, live animal imaging, disease biomarker detection, histopathology analysis, and environmental sensing.

Embodiments herein provide optical molecular imaging using novel squaraine rotaxane endoperoxides (SREPs) and squaraine catenane endoperoxides (SCEPs), interlocked fluorescent and chemiluminescent dye molecules that have a squaraine chromophore encapsulated inside a macrocycle endoperoxide. The dyes may be stored at low temperature, such as below 0° C., but, upon warming above 15° C., such as to body temperature, they undergo a unimolecular cycloreversion reaction that releases singlet oxygen and emits visible or near-infrared light that can pass through living tissue. The chemiluminescent signal is detectable with inherently high contrast because there is negligible background emission.

In embodiments, as an example, squaraine rotaxane endoperoxides may be synthesized by exposing a squaraine rotaxane to singlet oxygen. Exposing a squaraine rotaxane to singlet oxygen includes irradiating a squaraine rotaxane with light in the presence of air, or combining a squaraine rotaxane with a chemical source of singlet oxygen. A chemical source may be the precursor of or the product of a reaction. In an embodiment, singlet oxygen may be produced chemically by reaction of hydrogen peroxide with catalytic sodium molybdate.

In embodiments, chemiluminescent dye-stained microparticles and nanoparticles, referred to generally herein as “particles,” may also be prepared for detection and optical imaging applications.

In a SREP, the two main components remain bonded because the stopper groups at each end of the squaraine thread are generally too large to pass through the rotaxane macrocycle. This type of noncovalent attachment is often referred to as a mechanical bond, which provides a rich array of dynamic and stereochemical properties. By definition, the mechanical bond forces the interlocked components into close proximity, and there are several examples in the literature showing how one component can sterically protect the other from chemical attack. However, in embodiments herein, the close proximity of the two interlocked components induces steric strain in one of them and enhances chemical reactivity. More specifically, cross-component steric strain in a [2]rotaxane may be modulated in a systematic manner to control a chemical reaction of practical utility, namely the chemiluminescent cycloreversion of anthracene-9,10-endoperoxides.

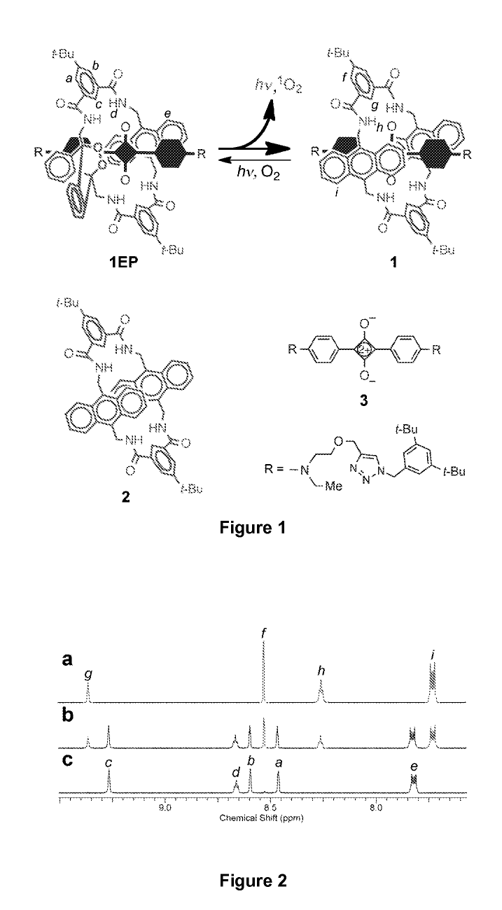

An exemplary compound described herein is identified as 1EP, an interlocked rotaxane, in particular a [2]rotaxane, comprised of a dumb-bell shaped squaraine dye encapsulated by a tetralactam macrocycle that contains a thermally unstable 9,10-anthracene endoperoxide group (FIG. 1). The cycloreversion reactions of aromatic endoperoxides exhibit chemiluminescence with weak emissions that have visible or red wavelengths. The relatively intense emissions from SREPs such as 1EP are surprising. As rotaxanes, SREPs are well suited for programmable chemiluminescence because the surrounding macrocycle endoperoxide acts as an energy source for the mechanically bonded squaraine chromophore whose excited singlet state emits light with high efficiency.

The encapsulation of squaraine 3 inside macrocycle 2 to make squaraine rotaxane 1 (see FIG. 1) may be achieved in high yield and in large scale using straightforward synthetic methods. Squaraine rotaxanes strongly absorb visible or near-infrared light and they are weak to moderate photosensitizers of molecular oxygen. Therefore, irradiation of squaraine rotaxane 1 with red light in the presence of air results in a 9,10-anthracene endoperoxide product. The highly selective formation of mono(endoperoxide) 1EP is noteworthy because it contrasts with the known reactivity of the free parent macrocycle 2 where both anthracene units are attacked by singlet oxygen. Apparently, the encapsulated squaraine prevents cycloaddition to the second anthracene unit in compound 1EP.

The formation of compound 1EP is extremely clean (see FIG. 2); extended irradiation does not lead to an additional photochemical reaction. No chemical change occurs if air is excluded from the irradiated sample. The molecular formula and molecular connectivity of compound 1EP were readily assigned by mass spectral and multidimensional NMR methods. Proof that the endoperoxide group is located inside the macrocycle (internal stereoisomer) was obtained using variable temperature ¹H NMR spectroscopy.

FIG. 2 shows ¹H NMR spectra illustrating the photoconversion of compound 1 into compound 1EP in accordance with various embodiments; partial ¹H NMR spectra in CDCl₃ show a) compound 1, b) a mixture of compound 1 and compound 1EP after irradiation with red light for 10 minutes, and c) complete conversion to compound 1EP after irradiation for 30 minutes; the specific atom labeling corresponds to that shown in FIG. 1 for compounds 1 and 1EP.

Typically, 9,10-dialkylanthracene endoperoxides undergo skeletal rearrangements rather than cycloreversion reactions. In notable contrast, endoperoxide 1EP cycloreverts at room temperature to completely regenerate the starting squaraine rotaxane and to release molecular oxygen. The rate constant for cycloreversion was determined by monitoring restoration of the anthracene absorption band centered at 372 nm. In o-xylene solvent at 38° C., the first order rate constant was 8.7×10⁻²h⁻¹, which corresponds to a half-life of 8 hours. Essentially the same rate constant was obtained when the solvent was changed to the more polar acetonitrile:water, 9:1.

An attractive feature with SREPs is the ability to store them at low temperature for extended periods. For example, the activation energy for 1EP cycloreversion is 88 kJ/mol, and there is no measurable reaction when samples are maintained below −20° C.

Another defining property of the endoperoxide cycloreversion process is the fraction of molecular oxygen that is released as excited state singlet oxygen. This fraction is conveniently determined by chemical trapping experiments that allow the endoperoxide cylcoreversion process to occur in the presence of large amounts of 2,3-dimethyl-2-butene. The 2,3-dimethyl-2-butene chemically reacts with released singlet oxygen to give a hydroperoxide product that is readily quantified by ¹H NMR spectroscopy. The observed ratio of trapped hydroperoxide product to regenerated squaraine rotaxane product in CDCl₃ indicated that 64±10% of the released molecular oxygen was excited state singlet oxygen and the rest was ground state triplet oxygen. This fraction changes with different experimental conditions, such as temperature, concentration, solvent, and with different SREP compounds.

The chemiluminescence and fluorescence emission for compound 1EP both produce maxima at 733 nm, which is significantly different from the maxima expected for singlet oxygen dimol emission (635 and 703 nm). This was confirmed by a control experiment that generated singlet oxygen in the absence of a chromophore and detected its dimol emission in the Ds Red (575-650 nm) channel. Thus, the chemiluminescence produced by compound 1EP is emitted from the encapsulated squaraine chromophore whose excited state is activated during the cycloreversion process.

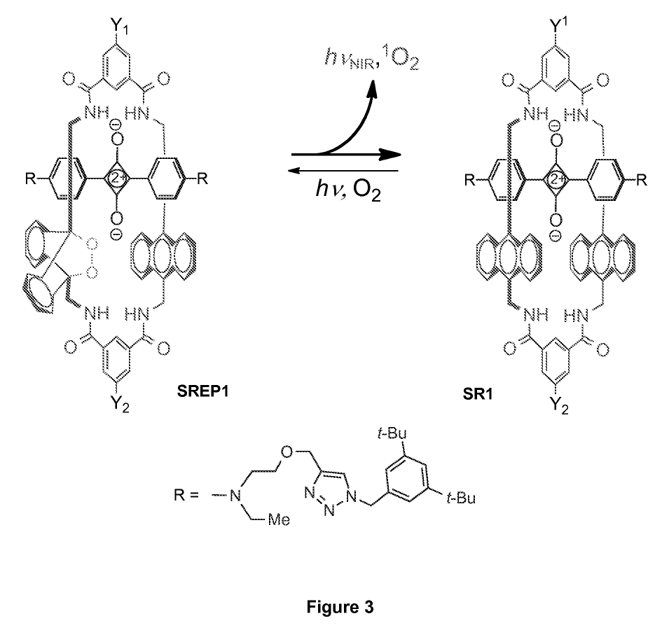

FIG. 3 illustrates an exemplary synthesis of a SREP compound (SREP 1) and the cycloreversion to the original squaraine rotaxane (SR1). Samples of SREP 1 emit light with a wavelength around 730 nm. Y₁ and Y₂ are each independently H, alkyl, phenyl, polar organic, non-polar organic, or a reactive group for conjugation.

In embodiments, compounds are provided having the formula:

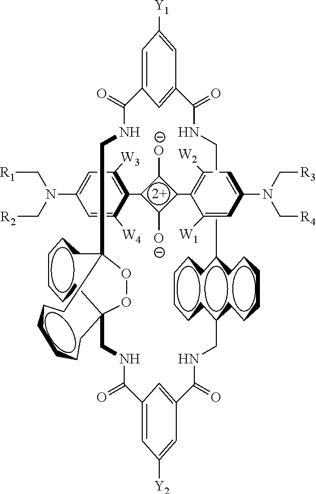

or a pharmaceutically acceptable salt thereof, wherein:

R₁, R₂, R₃, R₄, Y₁, and Y₂ are each independently H, alkyl, phenyl, polar organic, non-polar organic, or a reactive group for conjugation; and

W₁, W₂, W₃, and W₄ are each independently H or OH.

In embodiments, suitable polar organics include, but are not limited to, methoxy, alkoxy, benzyloxy, polyethylene glycol, amino, dialkylamino, halogen, triazole, amido, N-alkylamido, sulfone, sulfonate, phosphonate, and carboxylic ester. Suitable non-polar organics include, but are not limited to, alkyl, substituted alkyl, aryl, substituted aryl, heteroaryl, and substituted heteroaryl. Suitable reactive groups for conjugation include, but are not limited to carboxylic acid, carboxylic acid ester, alkyl hydroxysuccinimide ester, alkyl maleimide, alkyl isothiocyanate, alkyl azide, alkyl alkyne, alkyl haloacetamido, aryl ester, aryl hydroxysuccinimide ester, aryl maleimide, aryl isothiocyanate, aryl azide, aryl alkyne, and aryl haloacetamido.

A particular example is the structure shown in FIG. 3 with Y₁ and Y₂ as tert-butyl groups.

As illustrated in further examples below, the emission wavelength of the SREP is determined by the emission wavelength of the encapsulated squaraine chromophore. Modifications to the squaraine can be exploited to control the emission wavelength, as desired. For certain applications, controlling the rate of decay of the chemiluminescent SREP compound is also important. Modifications to the macrocycle endoperoxide structure generally have the more significant impact on the rate of decay.

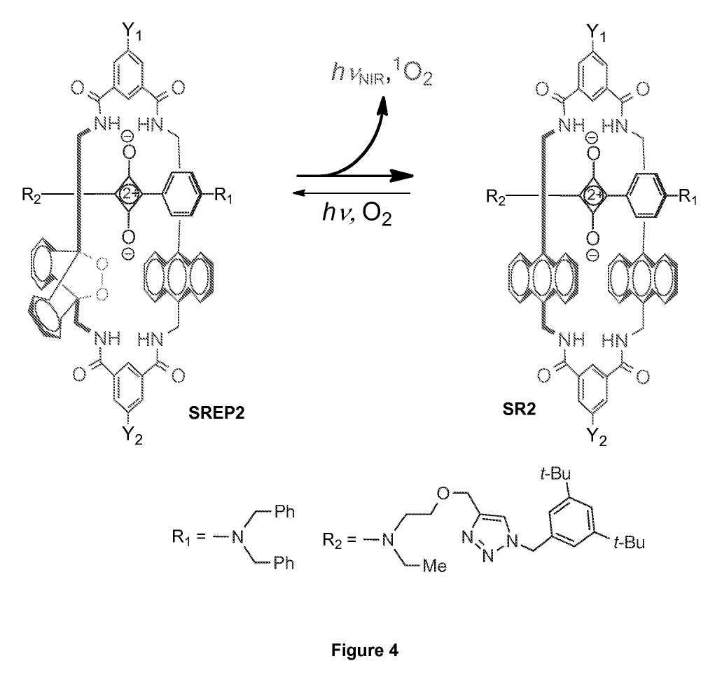

FIG. 4 illustrates an exemplary synthesis of SREP 2 and the cycloreversion to the original squaraine rotaxane (SR2). Samples of SREP 2 emit light with a wavelength around 525 nm. Y₁ and Y₂ are each independently H, alkyl, phenyl, polar organic, non-polar organic, or a reactive group for conjugation.

To generate SREP 2, a catalytic amount of Rose Bengal (bis-triethyl-ammonium salt) was added to a solution of SR2 in CDCl₃. This sample was continually aerated and exposed to a compact fluorescent lamp at 0° C. for 6 hours to achieve ˜100% conversion (verified by ¹H NMR). The catalytic Rose Bengal was removed prior to chemiluminescence studies.

SREP 2 was found to be chemiluminescent when heated. In solution state studies (1.5 mM, C₂D₂Cl₄), SREP 2 emits green light. Filter set manipulation allows for light to be seen only under the GFP channel (515-575 nm) of the Xenogen IVIS Lumina imaging station.

In embodiments, compounds are provided having the formula:

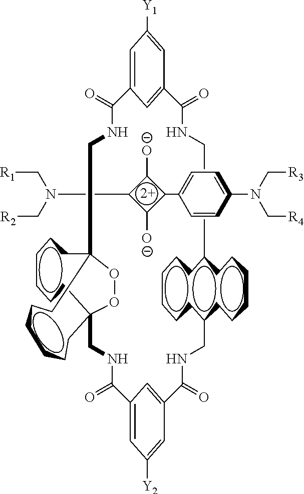

or a pharmaceutically acceptable salt thereof, wherein:

R₁, R₂, R₃, R₄, Y₁, and Y₂ are each independently H, alkyl, phenyl, polar organic, non-polar organic, reactive groups for conjugation.

A particular example is the structure shown in FIG. 4 with Y₁ and Y₂ as tert-butyl groups.

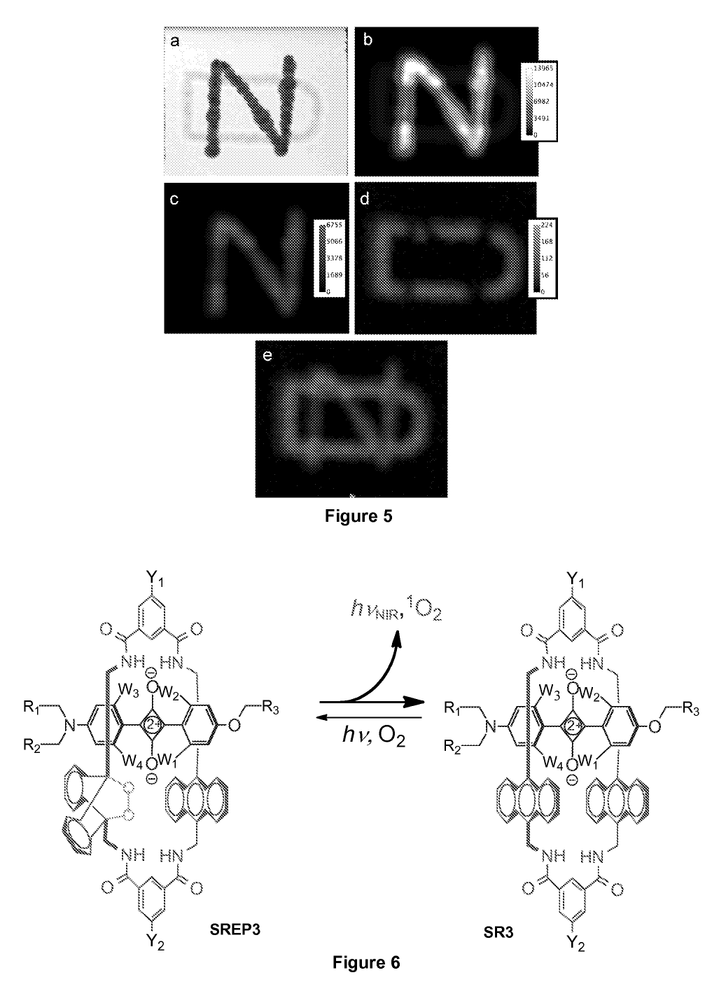

Surface state chemiluminescence was examined by spotting SREP solutions (CDCl₃, 1.7 mM) onto a reverse phase TLC plate. The samples were allowed to dry for 5 minutes and placed inside a Xenogen IVIS Lumina imaging system. As illustrated in FIG. 5, SREP 2 was spotted as a green “D” pattern and SREP 1 was spotted in a red “N” pattern on the same plate. FIG. 5 shows solid support images of green emitting SREP 2 and red emitting SREP 1, as follows: a) photographic image, b) no filter, c) red Cy5.5 filtered, d) green GFP filtered, and e) combination of images c and d. FIG. 5 illustrates that energy transfer occurs between SREP 1 and SREP 2. This effect may be exploited using such compounds to show when two targets are close to each other in physical space, for example using two different proteins or two different cells, for example, one labeled with SREP1 and the other labeled with SREP2. An alternative application is to show when two targets become separated. When two particles or molecules, such as one labeled with SREP1 and the other labeled with SREP2, are held together by a covalent or non-covalent bond there is energy transfer, but this energy transfer is lost when the bond is broken because of a chemical reaction (enzyme cleavage) or non-covalent displacement event. Similar energy transfer systems can be prepared using a target molecule or particle that is labeled with a SREP and a partner molecule or particle labeled with an energy accepting dye; the energy transfer is lost when the bond is broken because of a chemical reaction (enzyme cleavage) or non-covalent displacement event.

FIG. 6 illustrates an exemplary synthesis of a SREP compound (SREP 3) and the cycloreversion to the original squaraine rotaxane (SR3). Samples of SREP 3 emit light with a wavelength around 600 nm. R₁, R₂, R₃, Y₁, and Y₂ are each independently H, alkyl, phenyl, polar organic, non-polar organic, or a reactive group for conjugation. W₁, W₂, W₃, and W₄ are each independently H or OH.

In embodiments, compounds are provided having the formula

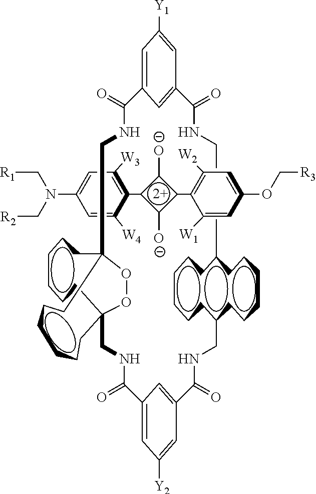

or a pharmaceutically acceptable salt thereof, wherein

R₁, R₂, R₃, Y₁, and Y₂ are each independently H, alkyl, phenyl, polar organic, non-polar organic, reactive groups for conjugation. W₁, W₂, W₃, and W₄ are each independently H or OH.

A particular example is the structure shown in FIG. 6 with Y₁ and Y₂ as tert-butyl groups, R₁ and R₂ as phenyl groups, and R₃ as a 4-substituted-1-(3′,5′-bis-tert-butylbenzyl)triazole.

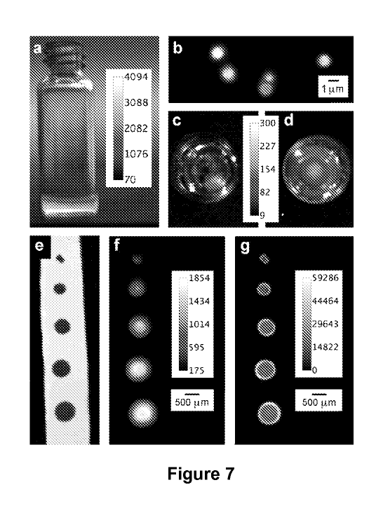

FIG. 7a shows a false-colored pixel intensity map of the emission from a solution of compound 1EP in CDCl₃ at 38° C. The chemiluminescence decreases over time but the decay is not a simple exponential, it is a biphasic curve with an initial rapid drop over the first few minutes followed by a slower decay with a half-life of several hours. A concentration study showed that the integrated chemiluminescence intensity for compound 1EP was essentially linear over a sixteen-fold concentration range, indicating the potential of SREPs to act as chemiluminescent tags for quantitative detection and sensing.

As noted above, chemiluminescent dye-stained microparticles and nanoparticles may also be prepared for in vivo near-infrared optical imaging.

Organic solutions of compound 1EP were used to stain hydrophobic surfaces and the cores of polymeric microparticles and nanoparticles (FIG. 7b), and chemiluminescence intensity maps of these materials were acquired using a commercial imaging station equipped with a CCD camera. FIG. 7c shows chemiluminescence from a group of stained, polystyrene particles that are aggregated in a vial containing water, while FIG. 7d depicts an aqueous dispersion of stained polystyrene particles that have been functionalized with carboxylate groups. Similar particle staining results can be obtained with polystyrene particles that have been functionalized with amino groups, biotin groups, and hydroxyl groups. The potential utility in surface based detection technologies was assessed by spotting samples of compound 1EP onto reverse-phase TLC plates (glass sheets supporting a thin layer of porous silica particles with impregnated C18 hydrocarbon). FIGS. 7e, 7f, and 7g show bright field, chemiluminescence, and fluorescence images, respectively, of a surface with a progression of spot sizes. The smallest spot is approximately 1 mm diameter, contains about 17 picomoles of compound 1EP, and is easily identified using either chemiluminescence or fluorescence imaging. This highlights the detection versatility of SREPs. Both compound 1EP and decay product 1 have essentially identical near-infrared fluorescence properties, thus the intrinsic bright fluorescence of a sample spot hardly changes as the chemiluminescence reaction proceeds, which means that the plate can be read by either imaging modality. In this case, the target background ratio (TBR) for fluorescence imaging is ˜70 and substantially better than chemiluminescence (TBR=4.5) because background autofluorescence from the plate is very low and the squaraine chromophore is excited multiple times by the excitation beam.

In an example, chemiluminescent and fluorescent molecular or particle probes are labeled with compound 1EP and conjugated to an antibody or related targeting protein like streptavidin, and the probe is used to identify target molecules such as oligonucleotides or proteins in Western blots or microarrays. Another example employs these optical probes in ELISA methods, sandwich assays, and particle capture agglutination assays. In each method, different probes can be fabricated with different colored SREP labels, thus enabling multiplex detection of the emission from a sample that has been treated with a mixture of probes, each with their own targeting selectivity, using different filter detection systems. The ability to image each sample using chemiluminescence or fluorescence using optical scanning machines, microscopes, or luminometers provides detection versatility. With samples that have little background autofluorescence, the best TBR ratio is gained using a fluorescence detection modality, but in samples that have high background autofluorescence, or suffer from light sensitivity, the more effective detection modality is chemiluminescence. Since the probes are both fluorescent and chemiluminescent, the operator has the flexibility to try both detection modalities using the same sample and choose the modality that gives the best performance.

In embodiments, microparticles and nanoparticles incorporating one or more chemiluminescent compound as described herein may be provided. Such particles may be used for various applications, including as contrast agents. Particles may be functionalized with and/or coated/bound to various surface agents, such as a surfactant to enhance movement of the particles within fluid/tissue. In an embodiment, impregnating a particle with a chemiluminescent compound at least partially protects the chemiluminescent compound from chemical degradation and quenching of the emission.

Microparticles and nanoparticles herein may function as contrast agents, optionally coated with a surfactant or functionalized with another surface agent, such that after introduction into an animal/human with a certain disease, the microparticles travel to and accumulate in target tissues based on the presence of target receptors, the presence of excessive or abnormal blood vessel development, etc. Such surface agents may be termed targeting agents as, in embodiments, they may be selected to target a particular receptor, cell, etc.

An exemplary targeting agent is a molecule that specifically binds with a target receptor in a tissue of interest or a target receptor that serves as an indicator of a particular disease. An exemplary targeting agent is an antibody that targets a specific antigen on the surface of cells in the target tissue. Another exemplary targeting agent is a vitamin such as biotin or folate that targets cells that overexpress receptors for these vitamins. Another exemplary targeting agent is a nickel coordination complex that targets cell proteins with sequences containing histidine tags. Another exemplary targeting agent is a halotag sequence that covalently targets cells that express the halotag acceptor protein.

In another embodiment, the particles become chemiluminescent and fluorescent at the target tissue because of the action of biochemical processes that eliminate emission quenching mechanisms. An example is enzymatic cleavage of energy accepting dyes that are covalently linked to the particle surface. This leads to increases in emission intensity at the target site.

The terms “microparticles” and “nanoparticles” refer to particles that range from about 0.005 to about 50 microns and comprising any suitable organic or inorganic material. The particles have different architectures that are produced by reliable synthesis procedures. Typically, the hydrophobic cores of the particles are doped with many copies of one of more SREP compounds. Protection inside the hydrophobic core blocks emission quenching processes and favors high emission intensity. The particle surface is functionalized covalently or non-covalently with the surface agents that produce targeting ability or energy acceptor ability.

The particles may be fabricated from biocompatible synthetic polymers or copolymers prepared from monomers such as, but not limited to, acrylic acid, methacrylic acid, ethyleneimine, crotonic acid, acrylamide, ethyl acrylate, methyl methacrylate, 2-hydroxyethyl methacrylate (HEMA), lactic acid, glycolic acid, c-caprolactone, acrolein, cyanoacrylate, bisphenol A, epichlorohydrin, hydroxyalkylacrylates, siloxane, dimethylsiloxane, ethylene oxide, ethylene glycol, hydroxyalkyl-methacrylates, N-substituted acrylamides, N-substituted methacrylamides, N-vinyl-2-pyrrolidone, 2,4-pentadiene-1-ol, vinyl acetate, acrylonitrile, styrene, p-amino-styrene, p-amino-benzyl-styrene, sodium styrene sulfonate, sodium 2-sulfoxyethylmethacrylate, vinyl pyridine, aminoethyl methacrylates, 2-methacryloyloxy-trimethylammonium chloride, polyvinylidene, polyacrylic acid, polyethyleneimine, polymethacrylic acid, polymethylmethacrylate, polysiloxane, polystyrene, polydimethylsiloxane, polylactic acid, poly(ε-caprolactone), epoxy resin, poly(ethylene oxide), poly(ethylene glycol), polyamide (nylon), polyvinylidene-polyacrylonitrile, polyvinylidene-polyacrylonitrile-polymethylmethacrylate, and polystyrene-polyacrylonitrile. Particle materials may also include polyfunctional crosslinking monomers such as N,N′-methylenebisacrylamide, ethylene glycol dimethacrylates, 2,2′-(p-phenylenedioxy)-diethyl dimethacrylate, divinylbenzene, triallylamine and methylenebis-(4-phenyl-isocyanate), including combinations thereof.

In an embodiment, the particles may be comprised of biological molecules such as phospholipids, lipids, proteins, oligonucleotides, and polysaccharides. These components provide the particle with mechanical strength, and the SREP compound is encapsulated covalently or non-covalently inside the particle.

In an embodiment, the particles comprise inorganic silica and the SREP compound is encapsulated covalently or non-covalently inside the particle. In another embodiment, the particles have multiple shells comprised of the different organic and inorganic materials listed above.

In an embodiment, the particles have magnetic properties because they contain added magnetic or superparamagnetic materials such as iron oxide.

In an embodiment, a method of fabricating a chemiluminescent particle is provided comprising providing a particle having a hydrophobic core and containing a squaraine rotaxane within the core, and irradiating the squaraine rotaxane with light in the presence of air to generate a squaraine rotaxane endoperoxide embedded within the core.

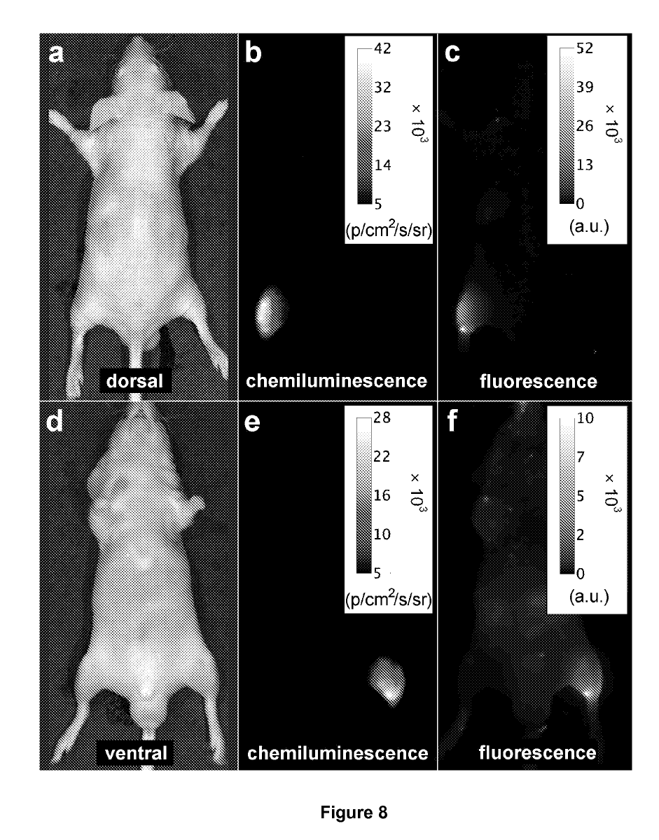

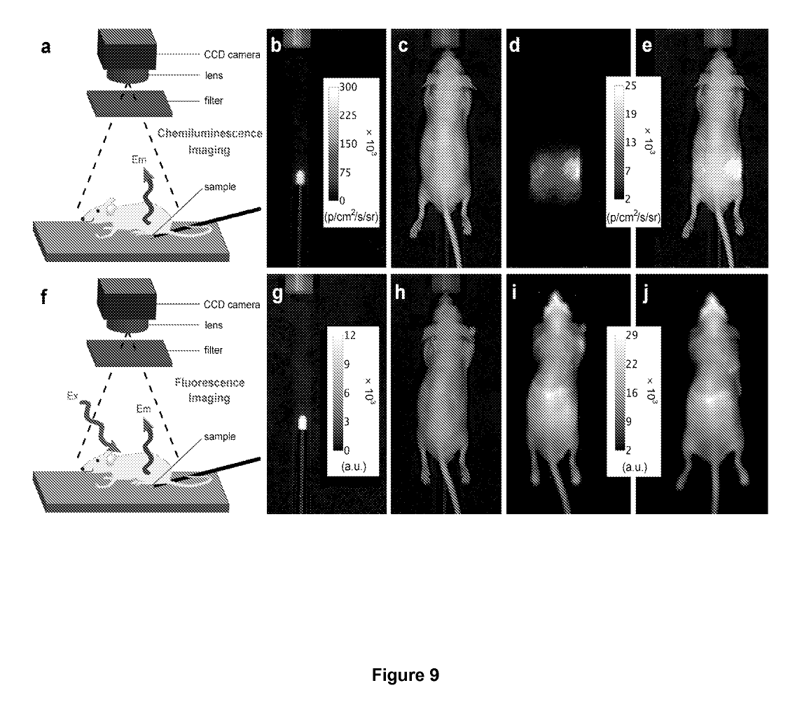

The planar optical images in FIG. 8 illustrate the potential value of SREP-labeled microparticles and nanoparticles as chemiluminescent imaging probes. An aliquot of carboxy functionalized 1EP-microparticles (50 μL) was injected subcutaneously into the dorsal side of a nude mouse leg. The top row in FIG. 8 shows high contrast chemiluminescence and reflected fluorescence dorsal images, which required light from the 1EP-microparticles to pass through ˜1 mm of skin. A region-of-interest (ROI) analysis indicated a TBR of 14 for chemiluminescence and 30 for fluorescence. The bottom row shows ventral images which required the light to penetrate a greater thickness of skin and leg tissue (˜7 mm). The target signal intensities are attenuated, but the chemiluminescence TBR of 10 remains very good, whereas, the fluorescence TBR of 4.4 is considerably lower. This signal contrast advantage for chemiluminescence increases with tissue penetration distance, as demonstrated by the phantom experiment in FIG. 9.

The top row of FIG. 9 shows that near-infrared chemiluminescence from a small tube containing a solution of compound 1EP (250 nmol) passes through a living nude mouse positioned between the tube and the CCD camera. The TBR for the transmitted light is an impressive 12, although the image is quite diffuse, which is a known characteristic of planar optical imaging, even at near-infrared wavelengths. Signal intensity is strongest at each side of the animal, which coincides with passage through the least amount of tissue. The bottom row in FIG. 9 depicts reflected fluorescence images of the same experimental arrangement as the top row but including excitation light (“Ex”); the fluorescence TBR is 1.1 and a comparison of FIGS. 9i and 9j shows that fluorescence from the target site (tube containing compound 1EP) cannot be readily distinguished from the background produced by scattering of the excitation light and animal autofluorescence. These mouse imaging results highlight a potentially attractive feature with SREPs as dual modality molecular imaging probes. They can be used in a high contrast chemiluminescence mode to locate relatively deep anatomical locations in vivo and subsequently employed in a fluorescent mode to identify the microscopic targets within thin histopathology sections taken from the same specimen.

SREPs, as exemplified by compound 1EP, represent a new paradigm for optical molecular imaging. They are easily generated by reaction with singlet oxygen that is produced by simple chemical or photochemical processes, and they can be stored and transported at low temperature until needed. Upon warming to body temperature, SREPs emit near-infrared light that can penetrate through living tissue with high target signal contrast. The chemiluminescent cycloreversion process insubstantially changes the photophysical properties of the encapsulated squaraine chromophore so a SREP can also be detected using fluorescence, thus providing versatile dual modality optical imaging capability. In many respects, chemiluminescent SREPs are conceptually similar to radiotracers, and they can likely be developed into the chemiluminescent equivalent of radiopharmaceuticals for complementary applications. For example, radiopharmaceuticals are suitable for deep-tissue imaging but they emit ionizing radiation that has an inherent dosimetric health risk. In contrast, chemiluminescent probes may be restricted to shallower tissues or anatomical sites that can be reached by endoscopes. However, SREPs do not emit harmful radiation, so they may be more appropriate for longitudinal molecular imaging studies that require repeated dosing of the probe, small animal studies that require high throughput, or for imaging protocols that gain advantages by employing cheaper, smaller, and safer optical imaging instrumentation. An attractive feature with the modular [2]rotaxane design is that the structural source of the excitation energy (the macrocycle endoperoxide) and the emission chromophore (the encapsulated squaraine) are orthogonal molecular building blocks that are connected by a non-covalent, mechanical bond. They can be modified independently and then interlocked in synthetic combinatorial fashion to create next-generation chemiluminent SREPs with improved performance.

Photochemical Synthesis of Compound 1EP. Rotaxane 1 (15.0 mg, 0.008 mmol) was dissolved in CDCl₃ (0.6 mL) and added to a standard NMR tube. The uncapped tube was placed 10 cm in front of a filtered (longpass 520 nm) 150 W Xenon lamp and irradiated for 30 minutes with exposure to atmospheric oxygen. Complete conversion to compound 1EP was confirmed by ¹H NMR spectroscopy. The solvent was removed under reduced pressure at ice bath temperature to give pure compound 1EP which was then stored as a solid or organic solution at temperatures below -20° C. until needed.

Chemical Synthesis of Compound 1EP. Rotaxane 1 (150 mg, 0.08 mmol) was dissolved in a microemulsion composed of non-ionic surfactant (C₁₀E₄) (300 mg), octane (1 g), and water (1 g) containing catalytic sodium molybdate. Hydrogen peroxide (30 μL) was added and the reaction was monitored by ¹H NMR spectroscopy. After extraction and washing, the solvent was removed under reduced pressure at ice bath temperature to give pure compound 1EP which was then stored as a solid or organic solution at temperatures below ˜20° C. until needed.

Staining Polymeric Particles with Compound 1EP. Polymeric microparticles: An aliquot of THF (160 μL) was added to 2.0 mL aqueous suspension of either 1.0% (w/v) polystyrene microparticles (5.3 μm diameter, Spherotech) or carboxylate modified polystyrene microparticles (0.9 μm diameter, Aldrich). The mixture was stirred for 1 hour at room temperature, to induce particle swelling, followed by addition of a solution of compound 1EP in cold THF (140 μL, 2.0 mM). After stirring for an additional 1 hour at 4° C., the mixture was centrifuged at 7,000 rpm for 2 minutes. The blue supernatant was discarded, and the blue pellet containing the stained microparticles was washed two times by adding 1 mL of aqueous sodium dodecylsulfate (0.05% w/v) followed by centrifugation at 7,000 rpm. The particles were finally washed with water and resuspended in water (140 μL) to give a colloidal suspension. Polymeric nanoparticles: An aliquot of THF (160 μL) was added to a 2.0 mL aqueous suspension of carboxylate modified polystyrene nanoparticles (20 nm diameter, Invitrogen). The mixture was stirred for 1 hour at room temperature, to induce particle swelling, followed by addition of a solution of compound 1EP in cold THF (140 μL, 2.0 mM). After stirring for an additional 1 hour at 4° C., the mixture was forced through a filter by centrifugation at 46,000 rpm for 7 minutes. The blue filtrate was discarded, and the blue residue containing the stained particles was washed two times by adding 1 mL of aqueous sodium dodecylsulfate (0.05% w/v) followed by centrifugation at 46,000 rpm for 7 minutes. The particles were resuspended in water (140 μL) to give a clear solution.

Staining Hydrophobic Surfaces: A microsyringe was used to make spots from a stock solution of compound 1EP (1.5 mM, CDCl₃) on a reverse-phase TLC plate (Analtech-Uniplate) that supported a 250 μm layer of porous silica gel particles (15 μm diameter) with impregnated C18 hydrocarbon.

Fabricating Silica Particles Containing Compound 1EP: Compound 1EP in cold ethanol was mixed with tetraethylorthosilicate and stirred for 20 minutes. Ammonium hydroxide solution was added and the solution stirred until it became homogeneous. The solution was added to a cold ethanol solution of tetraethylorthosilicate and then treated with ammonium hydroxide solution for 15 hours at cold temperature. The solution was centrifuged and the resulting blue precipitate was suspended in water.

Fabricating Silica Particles Containing Compound 1 and Photoactivation of Particles to Become Chemiluminescent: Micelles were prepared by dissolving 0.44 g of surfactant aerosol T and 800 μL of 1-butanol in 20 mL of water with stirring. 30 μL of compound 1 in DMF was added, followed by neat triethoxyvinylsilane (200 μL) and the micellar solution was stirred until it became clear. Then 10 μL of neat 3-aminopropyltriethoxysilane was added and the system was stirred for 20 hours. The nanoparticles containing 1 were purified by dialysis against water, and then irradiated for 6 hours with filtered light (520 longpass) which converted the entrapped compound 1 into 1EP and the particles became chemiluminescent.

Chemiluminescence and Fluorescence Imaging. Two sets of instrumentation were employed. Xenogen IVIS Lumina imaging system (Caliper Life Sciences, Alameda, Calif., USA) with a thermoelectrically cooled CCD camera: Solid phase and solution samples were placed on a heated stage set to 40° C. and at location position A (5 cm field of view). Typically, chemiluminescence was acquired over 60 seconds with large (8×8) binning, no filter, and the lens aperture fully open (Fₛₜₒₚ=1). Pixel intensity maps were acquired using Living Image software version 3.0, and the data was analyzed using ImageJ software version 1.43r. Andor iXon EMCCD camera with a thermoelectrically cooled CCD and a 25 mm lens: Solution samples were placed on a heated stage and chemiluminescent spectra were acquired using an Acton spectrometer with monochromator set to 750 nm and 1 mm slit width. Fluorescence spectra employed a laser (˜200 μW) for excitation at 650 nm and 8 ms acquisition time.

Animal Imaging. The nude mouse (strain NCr Foxn1^{nu}) in FIG. 8 was euthanized by cervical dislocation before study and the carcass maintained at 38° C. using a heating pad and heated stage. The carboxylate functionalized 1EP-microparticles dispersed in water (50 μL, containing ˜10⁹ microparticles and 50 nmol of compound 1EP) were injected subcutaneously. The chemiluminescence images were acquired for 5 minutes with large binning. The fluorescence images were acquired for 1 second with 4×4 binning. The live nude mouse used in FIG. 9 was anesthetized using 2-3% v/v isoflurane and maintained at 1.5-2% v/v isoflurane during imaging. The tube containing compound 1EP was maintained at 38° C. and the chemiluminescence images were acquired for 5 minutes with large binning. The fluorescence images were acquired for 5 seconds with small binning.

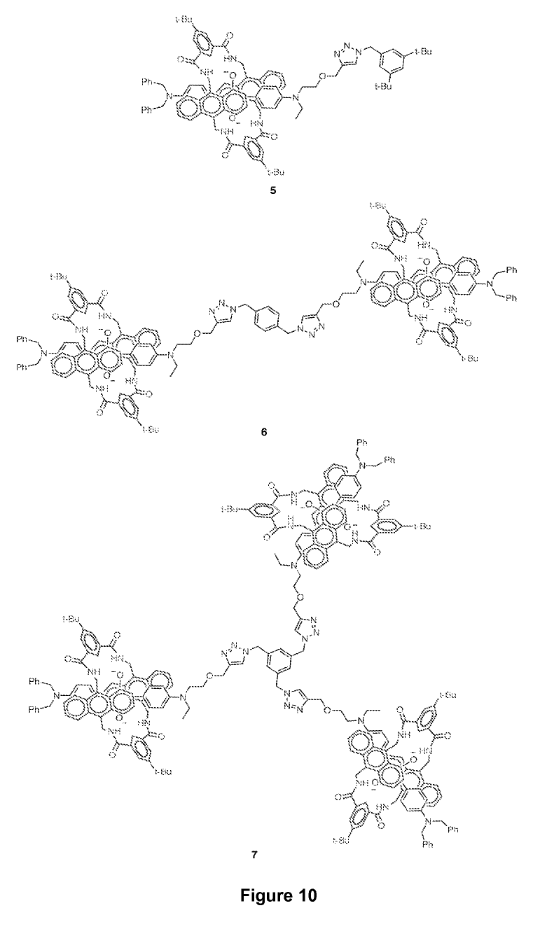

Comparison of Monomer SREPs to Dimer and Trimer Versions: The above examples generally refer to monomeric SREPs; however, these compounds may be present in multimeric or polymeric forms, such as dimers, trimers, etc. FIG. 10 illustrates an exemplary monomer (5), a dimer (6), and a trimer (7). As used herein, the term “multimers” refers to covalent molecules that are linear, dendritic, or branched oligomers or polymers that have multiple copies of a monomeric unit.

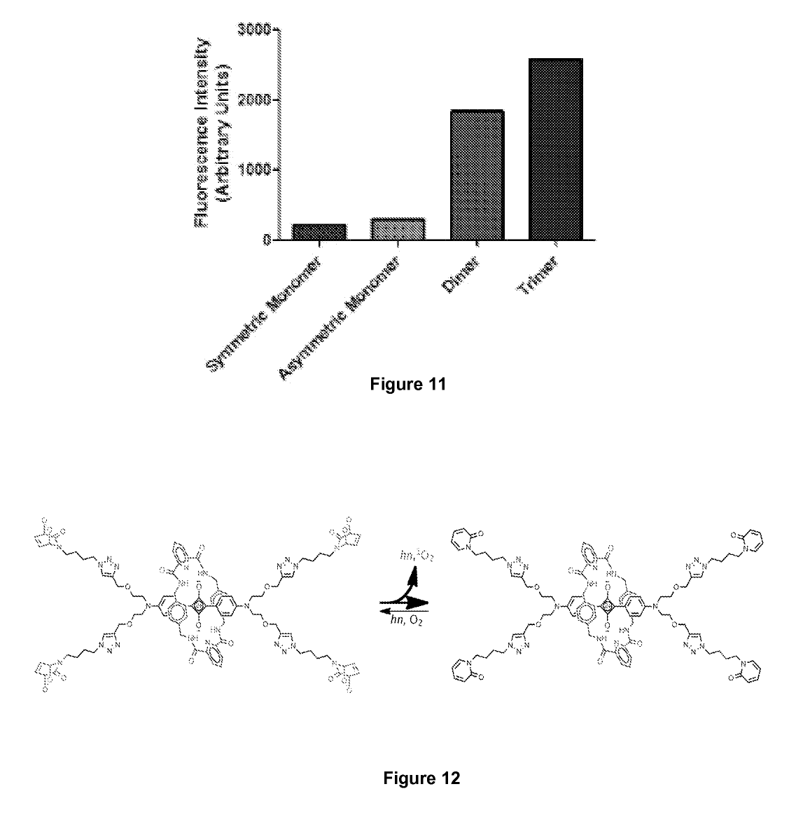

FIG. 11 is a graph comparing initial chemiluminescent intensity counts of symmetric monomers and asymmetric monomers, as well as dimers and trimers. For the comparison of FIG. 11, the rotaxane concentrations were not identical, rather the endoperoxide equivalents were fixed, which means that the monomers were studied at 1.0 mM; dimer 6 at 0.5 mM, and trimer 7 at 0.3 mM. The results indicate that multimeric endoperoxides increase the local effective concentration resulting in an increased signal from lower concentrations. The localized concentration effect can be seen as the dimer is approximately 6 times brighter while the trimer is approximately 9 times brighter (both with respect to the unsymmetrical monomer 5). This result provides evidence for a significant signal increase for multimers or polymers of SREPs at lower molecular concentrations.

Further embodiments herein utilize the foundational understanding of SREPs to provide a variety of chemiluminescent compounds or constructs. In an embodiment, a chemiluminescent system may comprise a chromophore and an endoperoxide associated with the chromophore. The term “associated with” may cover a variety of associative mechanisms, including non-covalent bonds, covalent bonds, mechanical bonds, and co-location within a particle

In various embodiments, a chromophore compound and an endoperoxide compound may be non-covalently mixed to provide a relatively low intensity chemiluminescent system due to the relatively inefficient transfer of energy from the released singlet oxygen to the chromophore. Further enhancement of chemiluminescence is gained by embedding the chromophore and endoperoxide in a particle, such as a bead, providing close proximity of the reactive components along with protection from degradation. Providing more intense chemiluminescence, the chromophore and the endoperoxide can be covalently linked. For example, embodiments may be provided in which the squaraine chromophore is covalently connected to one or more copies of a suitable endoperoxide group that thermally releases singlet oxygen.

FIG. 12 shows a squaraine rotaxane with a phenylene containing macrocycle that does not react with singlet oxygen but it is able to accept energy from singlet oxygen. Linked to the squaraine chromophore are four pyridone-3,6-endoperoxides that thermally release singlet oxygen at 38° C. and the conjugate produces a thermally-activated chemiluminescence emission at 700 nm.

The chromophore component could be a squaraine rotaxane or a squaraine catenane, but it may also be phthalocyanine, porphyrin, rhodamine, or any other suitable chromophore that is highly fluorescent and does not react readily with singlet oxygen. Generally, selection of the particular chromophore will impact or control the color and intensity of chemiluminescence. In embodiments, the endoperoxide is storable at low temperature of below 0° C., and releases singlet oxygen at a temperature above 15° C. The endoperoxide may be a pyridone-3,6-endoperoxide or other compounds such as naphthalene-1,4-endoperoxides or related aromatic endoperoxide.

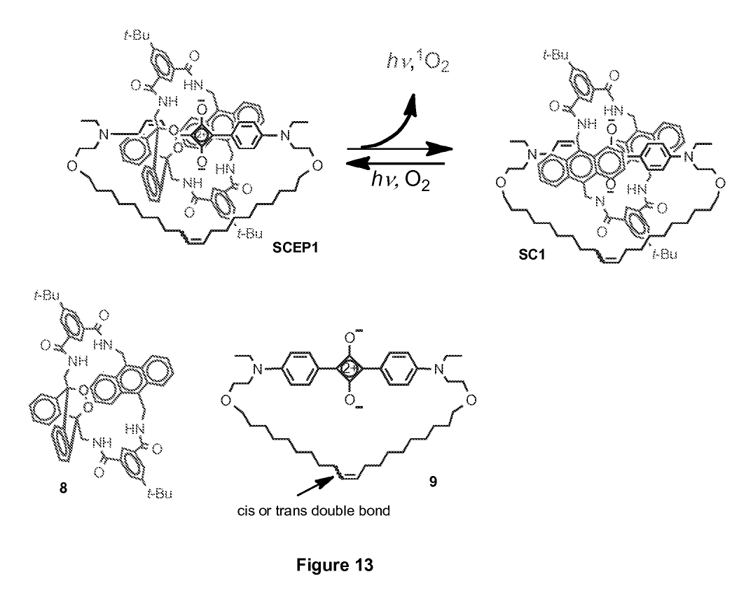

In various embodiments, the end groups of a SREP may be covalently connected to form a squaraine catenane endoperoxide (SCEP). FIG. 13 shows an exemplary synthesis of SCEP 1, an interlocked molecule comprised of the two macrocyles 8 and 9, and the cycloreversion to the original squaraine catenane (SC1). Samples of SCEP 1 emit light with a wavelength around 730 nm and have similar photophysical properties as the analogous rotaxane 1EP, but SCEP 1 emits higher chemiluminescence intensity than the analogous 1EP when encapsulated inside a polystyrene nanoparticle (20 nm diameter).

Although certain embodiments have been illustrated and described herein, it will be appreciated by those of ordinary skill in the art that a wide variety of alternate and/or equivalent embodiments or implementations calculated to achieve the same purposes may be substituted for the embodiments shown and described without departing from the scope. Those with skill in the art will readily appreciate that embodiments may be implemented in a very wide variety of ways. This application is intended to cover any adaptations or variations of the embodiments discussed herein. Therefore, it is manifestly intended that embodiments be limited only by the claims and the equivalents thereof.

1. A compound having the formula: 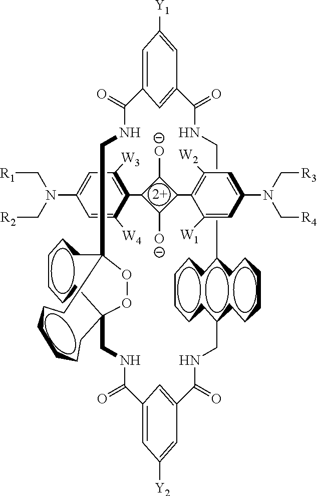
or a pharmaceutically acceptable salt thereof, wherein:
R₁, R₂, R₃, R₄, Y₁ and Y₂ are each independently H, alkyl, phenyl, polar organic, non-polar organic, or a reactive group for conjugation; and
W₁, W₂, W₃, and W₄ are each independently H or OH.

2. The compound of claim 1, wherein at least one of R₁, R₂, R₃, R₄, Y₁ and Y₂ is a polar organic selected from methoxy, alkoxy, benzyloxy, polyethylene glycol, amino, dialkylamino, halogen, triazole, amido, N-alkylamido, sulfone, sulfonate, phosphonate, and carboxylic ester.

3. The compound of claim 1, wherein at least one of R₁, R₂, R₃, R₄, Y₁ and Y₂ is a non-polar organic selected from alkyl, substituted alkyl, aryl, substituted aryl, heteroaryl, and substituted heteroaryl.

4. The compound of claim 1, wherein at least one of R₁, R₂, R₃, R₄, Y₁ and Y₂ is a reactive group for conjugation selected from carboxylic acid, carboxylic acid ester, alkyl hydroxysuccinimide ester, alkyl maleimide, alkyl isothiocyanate, alkyl azide, alky alkyne, alkyl haloacetamido, aryl ester, aryl hydroxysuccinimide ester, aryl maleimide, aryl isothiocyanate, aryl azide, aryl alkyne, and aryl haloacetamido.

5. The compound of claim 1, wherein the compound emits light having a wavelength of about 730 nm.

6. The compound of claim 1, wherein the compound is present in a multimeric form.

7. A compound having the formula: 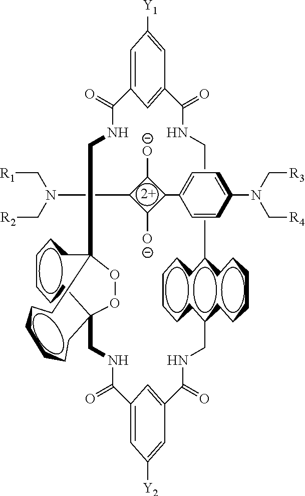
or a pharmaceutically acceptable salt thereof, wherein:
R₁, R₂, R₃, R₄, Y₁ and Y₂ are each independently H, alkyl, phenyl, polar organic, non-polar organic, or a reactive group for conjugation.

8. The compound of claim 7, wherein at least one of R₁, R₂, R₃, R⁴, Y₁ and Y₂ is a polar organic selected from methoxy, alkoxy, benzyloxy, polyethylene glycol, amino, dialkylamino, halogen, triazole, amido, N-alkylamido, sulfone, sulfonate, phosphonate, and carboxylic ester.

9. The compound of claim 7, wherein at least one of R₁, R₂, R₃, R₄, Y₁ and Y₂ is a non-polar organic selected from alkyl, substituted alkyl, aryl, substituted aryl, heteroaryl, and substituted heteroaryl.

10. The compound of claim 7, wherein at least one of R₁, R₂, R₃, R₄, Y₁ and Y₂ is a reactive group for conjugation selected from carboxylic acid, carboxylic acid ester, alkyl hydroxysuccinimide ester, alkyl maleimide, alkyl isothiocyanate, alkyl azide, alky alkyne, alkyl haloacetamido, aryl ester, aryl hydroxysuccinimide ester, aryl maleimide, aryl isothiocyanate, aryl azide, aryl alkyne, and aryl haloacetamido.

11. The compound of claim 7, wherein the compound emits light having a wavelength of about 525 nm.

12. The compound of claim 7, wherein the compound is present in a multimeric form.

13. A compound having the formula: 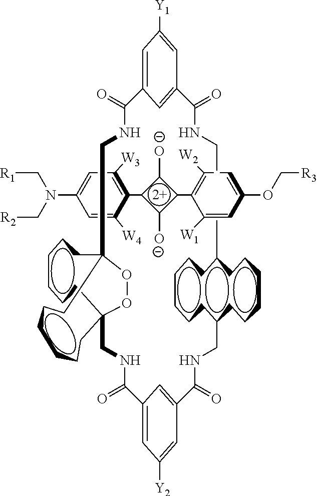
or a pharmaceutically acceptable salt thereof, wherein:
R₁, R₂, R₃, Y₁ and Y₂ are each independently H, alkyl, phenyl, polar organic, non-polar organic, or a reactive group for conjugation; and
W₁, W₂, W₃, and W₄ are each independently H or OH.

14. The compound of claim 13, wherein at least one of R₁, R₂, R₃, Y₁ and Y₂ is a polar organic selected from methoxy, alkozy, benzyloxy, polyethylene glycol, amino, dialkylamino, halogen, triazole, amido, N-alkylamido, sulfone, sulfonate, phosphonate, and carboxylic ester.

15. The compound of claim 13, wherein at least one of R₁, R₂, R₃, Y₁ and Y₂ is a non-polar organic selected from alkyl, substituted alkyl, aryl, substituted aryl, heteroaryl, and substituted heteroaryl.

16. The compound of claim 13, wherein at least one of R₁, R₂, R₃, Y₁ and Y₂ is a reactive group for conjugation selected from carboxylic acid, carboxylic acid ester, alkyl hydroxysuccinimide ester, alkyl maleimide, alkyl isothiocyanate, alkyl azide, alky alkyne, alkyl haloacetamido, aryl ester, aryl hydroxysuccinimide ester, aryl maleimide, aryl isothiocyanate, aryl azide, aryl alkyne, and aryl haloacetamido.

17. The compound of claim 13, wherein the compound emits light having a wavelength of about 600 nm.

18. The compound of claim 13, wherein the compound is present in a multimeric form.

19. A compound having the formula: 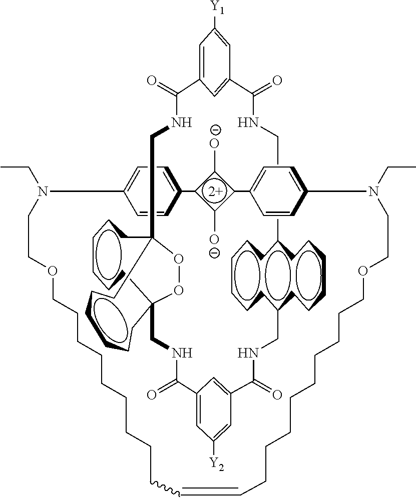
or a pharmaceutically acceptable salt thereof, wherein:
Y₁ and Y₂ are each independently H, alkyl, phenyl, polar organic, non-polar organic, or a reactive group for conjugation.

20. The compound of claim 19, wherein at least one of Y₁ and Y₂ is a polar organic selected from methoxy, alkoxy, benzyloxy, polyethylene glycol, amino, dialkylamino, halogen, triazole, amido, N-alkylamido, sulfone, sulfonate, phosphonate, and carboxylic ester.

21. The compound of claim 19, wherein at least one of Y₁ and Y₂ is a non-polar organic selected from alkyl, substituted alkyl, aryl, substituted aryl, heteroaryl, and substituted heteroaryl.

22. The compound of claim 19, wherein at least one of Y₁ and Y₂ is a reactive group for conjugation selected from carboxylic acid, carboxylic acid ester, alkyl hydroxysuccinimide ester, alkyl maleimide, alkyl isothiocyanate, alkyl azide, alky alkyne, alkyl haloacetamido, aryl ester, aryl hydroxysuccinimide ester, aryl maleimide, aryl isothiocyanate, aryl azide, aryl alkyne, and aryl haloacetamido.

23. The compound of claim 19, wherein the compound emits light having a wavelength of about 730 nm.

24. The compound of claim 19, wherein the compound is present in a multimeric form.

25. A method of synthesizing a squaraine rotaxane endoperoxide, comprising exposing a squaraine rotaxane to singlet oxygen, wherein exposing a squaraine rotaxane to singlet oxygen comprises irradiating a squaraine rotaxane with light in presence of air.

26-31. (canceled)

32. A method of synthesizing a squaraine catenane endoperoxide, comprising exposing a squaraine catenane to singlet oxygen.

33. The method of claim 32, wherein exposing a squaraine catenane to singlet oxygen comprises exposing to singlet oxygen a squaraine catenane having the formula:

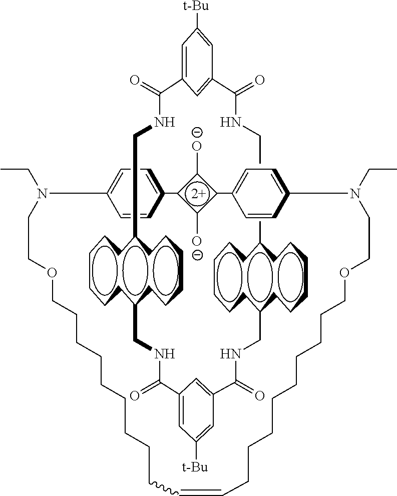

34-49. (canceled)

50. A method of fabricating a chemiluminescent particle, comprising:
providing a particle having a hydrophobic core and containing a squaraine rotaxane or squaraine catenane within the core; and
irradiating the squaraine rotaxane or squaraine catenane with light in presence of air to generate a squaraine rotaxane endoperoxide or squaraine catenane endoperoxide embedded within the core.
